(19) United States
(12) Patent Application Publication
(10) Pub. No.: US 2016/0070946 A1
(43) Pub. Date: Mar. 10, 2016

(54) System for Authenticating Goods

(71) Applicant: The Procter & Gamble Company, Cincinnati, OH (US)

(72) Inventors: Jonathan Richard Stonehouse, Windlesham (GB); Christopher Hebden Nunn, Egham (GB); Gavin Mew, Staines (GB)

(21) Appl. No.: 14/478,004

(22) Filed: Sep. 5, 2014

(51) Int. Cl. G06K 7/12; G06K 19/06

(52) U.S. Cl. CPC G06K 7/12; G06K 19/0614; G06K 2019/06225

(57) ABSTRACT

A system for identifying authentic goods. The system including: an illumination source having an output associated with a first wavelength distribution, the first wavelength distribution having a first average wavelength; a viewing filter element, the viewing filter element allowing either (i) only light with wavelength greater than the first average wavelength to pass and cutting out the first energy wavelength and lower or (ii) eliminating light with a wavelength less than the first wavelength distribution and allowing light with the same or greater wavelength distribution as the first wavelength to pass or (iii) allowing a specific bandwidth of radiation with an average wavelength that is longer than the first wavelength distribution to pass; a key for identifying authentic goods utilizing the illumination source and the viewing filter element

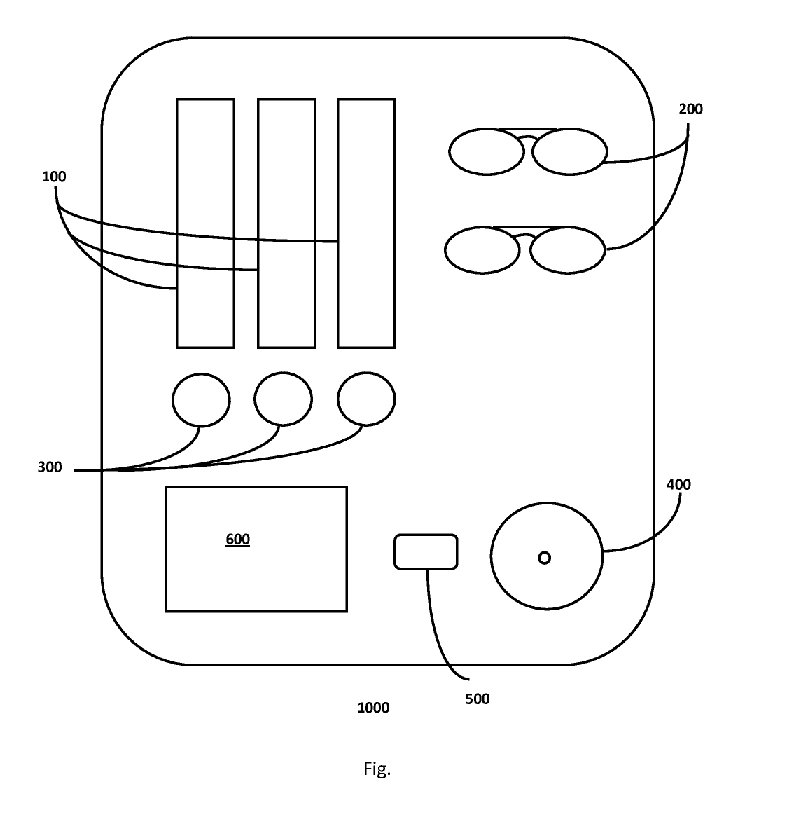

### FIELD OF THE INVENTION

The invention relates to systems and methods for validating or authenticating goods. The systems and methods relate particularly to the authentication of goods comprising polymers or polymeric packaging materials.

### BACKGROUND OF THE INVENTION

Packaged consumer goods are well known in the arts. Most packaged goods are produced and sold in association with one or more trademarks. In many instances there is substantial equity in the trademarks and the value of branded goods can be closely tied to the marks.

The use of trademarks and trade dress in consumer goods provides shoppers with an indication of the origin of the goods and facilitates the purchase of goods based upon a reliance relating to that origin. This may be particularly true for products where the quality, durability or efficacy of the actual product cannot be determined at the time of purchase. In such instances, the shopper is left with little to base their purchase upon besides the appearance of the goods and the presence of the proper trademarks.

Counterfeiters are often able to exploit this situation by producing articles which appear similar or identical to the authentic goods, but which may be produced at a fraction of the cost of the authentic goods since the counterfeiter is not concerned with the quality or efficacy of the goods but only with matching the appearance of the authentic goods.

What is needed are systems and methods for differentiating between authenticate and counterfeit products which cannot easily be adopted by the counterfeiters into their activities.

### SUMMARY OF THE INVENTION

A system for identifying authentic goods. The system including: an illumination source having an output associated with a first wavelength distribution, the first wavelength distribution having a first average wavelength; a viewing filter element, the viewing filter element allowing either (i) only light with wavelength greater than the first average wavelength to pass and cutting out the first energy wavelength and lower or (ii) eliminating light with a wavelength less than the first wavelength distribution and allowing light with the same or longer wavelength distribution as the first wavelength to pass or (iii) allowing a specific bandwidth of radiation with an average wavelength that is greater than the first wavelength distribution to pass; a key for identifying authentic goods utilizing the illumination source and the viewing filter element.

### BRIEF DESCRIPTION OF THE DRAWINGS

Fig. provides a schematic illustration of an embodiment of the invention.

### DETAILED DESCRIPTION OF THE INVENTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

In one aspect the system comprises an illumination element, a filtered viewing element and a product key. The illumination element comprises source of electromagnetic radiation adapted to provide radiation associated with a particular wavelength distribution having a particular average wavelength. The filtered viewing element provides a mechanism for removing part of the overall incident radiation, and passing radiation having an average wavelength substantially greater than the average wavelength associated with the illumination source.

The illumination source may be any know source of electromagnetic radiation. The source may have a brad spectrum output in terms of wavelength or a narrowly tailored wavelength output. The output of the source may be passed through a filter element to restrict the final radiation output of the source. Exemplary filter elements include tinted glass or polymeric filter elements. Exemplary illumination sources include typical flashlights as well as light emitting diode (LED) lights associated with narrow or broad output spectra.

The viewing element may comprise a camera having a colored filter fitted to its lens, or color tinted glasses enabling a user to directly observe the impact of the prescribed illumination upon the target objects.

The system may be provided as a kit. The kit may comprise a single illumination source and single filtered viewing element, or the kit may comprise multiple pairs of illumination and viewing elements. The relationship of the viewing and illumination element pairs remains that the filtered element serve as a low pass filter in terms of wavelength, allowing the passage of a distribution of radiation having an average wavelength value higher than the output of the source used for the initial illumination. The filtered viewing elements may also filter radiation having a wavelength above a particular value, thereby serving as a band pass filter. Additional illumination and viewing elements may also be provided as single elements.

The viewing element may comprise an electronic viewing element having a viewing sensitivity of a particular range. The range has an average wavelength which is greater than the average wavelength of the illumination source output. In one embodiment, the viewing element has a range sensitive to radiation of a wavelength greater than about 700 nm.

The reaction of polymeric materials to incident radiation varies according to a number of factors including the specific details of the formulation of the polymeric material. In practice this results in similar looking materials with differing formulations having distinctly differing appearances when viewed under particular circumstances. As an example, two plastic containers which appear to be the same shade of yellow under broad spectrum (white) light, may appear different when illuminated using a light source emitting only blue light, or emitting white light reduced to blue light, using a color filter, and viewed using a red tinted color filter viewing element. Due to this set of circumstances, the opportunity exists to differentiate authentic packages having a particular formulation from counterfeit packages lacking that formulation.

The key comprises information enabling a user to differentiate authentic from non-authentic items. The information may be provided in the form of images showing the appearance of authentic goods when such goods are illuminated by the illumination source and viewed by the filtered viewing element. The key may comprise this information in printed or electronic form. The information may be provided over a network to a display device utilized by the system user. Such distribution of the information enables the information provider greater flexibility in keeping the information accurate as package materials change over time.

The information may comprise production or other coded information which will be visible using the method of illumination and viewing disclosed herein. A user will illuminate an object and view the illuminated object with the viewing element. The user will then refer to the key as necessary to determine if the viewed object is authentic or counterfeit in terms of the information provided by the key.

In one embodiment, a viewer may be employed for capturing near infrared radiation. IN this embodiment, a portion of the target item may be illuminated either specifically with near infrared radiation, or generally with a broad spectrum source which includes near infrared radiation. Indicia may be printed upon the target object utilizing inks which do not absorb near infrared radiation. Counterfeit objects may be printed with inks which do absorb near infrared radiation. In this instance, viewing the two respective objects will reveal a differentiating factor as the absorbent inks will appear dark with the infrared viewer while the indicia of the authentic target object will not be visible under the near infrared viewing.

In one aspect the key may be provided as a sample of authentic product. In this embodiment, the user of the system may directly compare the appearance of the authentic and test objects under the illumination source and viewed via the filtered element.

Without being bound by theory, it is believed that sufficient differences in the materials of counterfeit goods, compared to authentic goods may be revealed using the system and method disclosed herein to enable an efficient differentiation of the goods to be undertaken by a user.

In one embodiment, a kit may be provided with one or more light sources, exemplary sources include high intensity white LED sources, narrow output LED sources, and forensic investigation light sources. The lit further includes source filters and viewing elements such as those available from Comar Optics, Edmonton, AB, CA. The kit may contain near infrared viewers created by modifying smart phones optics by removing a near infrared filter and installing a visible light filter.

As illustrated in the FIGURE, a kit 1000 includes illumination sources 100, viewing elements 200, light filters 300, CD based key 400, USB flash drive key 500, snd authentic product 600.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for identifying authentic goods, the system comprising:
a. an illumination source having an output associated with a first wavelength distribution, the first energy distribution having a first average wavelength;
b. a viewing element, the viewing filter element associated with a second wavelength distribution, the second wavelength distribution having a second average wavelength, the second average wavelength being substantially longer than the first average wavelength;
c. a key for identifying authentic goods utilizing the illumination source and the viewing filter element.

2. The system according to claim 1 wherein the viewing element comprises an electronic viewing system.

3. The system according to claim 1 further comprising an additional illumination source associated with a third wavelength distribution having a third average wavelength.

4. The system according to claim 1 further comprising an additional viewing filter element, the additional viewing filter element associated with an additional wavelength distribution having an additional average wavelength.

5. The system according to claim 1 further comprising an additional illumination source associated with a third energy distribution having a third average wavelength, and an additional viewing filter element, the additional viewing filter element associated with an additional wavelength distribution having an additional average wavelength.

6. The system according to claim 1 wherein the key comprises an image of an authentic product illuminated by the first wavelength distribution and viewed using the second wavelength distribution.

7. The system according to claim 6 wherein the image comprises a printed image.

8. The system according to claim 6 wherein the image comprises a display of an electronically stored image.

9. The system according to claim 8 wherein the electronically stored image is provided over a network to a display device.

10. The system according to claim 6 wherein the image comprises a printed production code.

11. The system according to claim 1 wherein the key comprises an authentic product.

12. A method for identifying authentic goods, the method comprising steps of:
a. providing an illumination element;
b. providing a viewing element;
c. providing a key;
d. illuminating a product with the illumination element;
e. viewing the illuminated product using the viewing element;
f. using the key to interpret the viewed good as authentic or not.
